(19) United States
(12) Patent Application Publication
(10) Pub. No.: US 2025/0336113 A1
(43) Pub. Date: Oct. 30, 2025

(54) IMAGE ITERATIVE DECOMPOSITION METHOD AND COMPUTER DEVICE

(71) Applicant: Shanghai United Imaging Healthcare Co., Ltd., Shanghai (CN)

(72) Inventors: Zhi Liu, Shanghai (CN); Dongmei Yan, Shanghai (CN); Meili Yang, Shanghai (CN); Jianwei Fu, Shanghai (CN)

(21) Appl. No.: 19/189,309

(22) Filed: Apr. 25, 2025

(30) Foreign Application Priority Data
Apr. 25, 2024 (CN) 202410509930.3

(51) Int. Cl. G06T 11/00; G06T 5/50; G06T 5/70; G06T 7/00

(52) U.S. Cl. CPC G06T 11/008; G06T 5/50; G06T 5/70; G06T 7/0014; G06T 2207/10081; G06T 2207/30004; G06T 2210/41; G06T 2211/424

(57) ABSTRACT

The present disclosure relates to an image iterative decomposition method, which includes: determining a noise model based on scanned images of an object to be examined at different scan energies; constructing an iterative decomposition function based on the scanned images and the noise model; and obtaining a target material density image by solving the iterative decomposition function. The noise model represents noise distribution information of each scanned image. The iterative decomposition function is configured to perform noise reduction and material decomposition on the scanned images.

### CROSS-REFERENCE TO RELATED APPLICATIONS

The present disclosure claims priority to Chinese patent application No. 202410509930.3, titled “IMAGE ITERATIVE DECOMPOSITION METHOD AND APPARATUS, AND COMPUTER DEVICE”, filed on Apr. 25, 2024, the entire content of which is incorporated herein by reference.

### TECHNICAL FIELD

The present disclosure relates to the field of medical technologies, and in particular, to an image iterative decomposition method and a computer device.

### BACKGROUND

Computed Tomography (CT) is widely used in the medical field.

Taking dual-energy CT and photon counting CT as examples, they can use the acquired spectral information of two or more energy intervals to perform decomposition on a base material in a scanned object, so as to obtain a material density image of the base material for clinical diagnosis.

However, the process of obtaining the material density image using multispectral information is affected by various factors, which leads to a degradation in the signal-to-noise ratio of the decomposed material density image and results in poor image quality.

### SUMMARY

In a first aspect, the present disclosure provides an image iterative decomposition method, including:
determining a noise model based on scanned images of an object to be examined at different scan energies, the noise model representing noise distribution information of each scanned image;
constructing an iterative decomposition function based on the scanned images and the noise model, the iterative decomposition function being configured to perform noise reduction and material decomposition on the scanned images; and
obtaining a target material density image by solving the iterative decomposition function.

In an embodiment, determining the noise model based on the scanned images of the object to be examined at different scan energies includes:
for each scanned image at each scan energy, obtaining a noise distribution image of each scanned image, the noise distribution image representing a noise level of each pixel in each scanned image; and
determining the noise model based on the noise distribution image of each scanned image.

In an embodiment, after determining the noise model based on the scanned images of the object to be examined at different scan energies, the method further includes: determining a priori material density image based on reference images at different scan energies. Constructing the iterative decomposition function based on the scanned images and the noise model includes: determining the iterative decomposition function based on the scanned images, the noise model, and the priori material density image.

In an embodiment, determining the prior material density image based on the reference images at different scan energies includes:
determining a reference linear attenuation coefficient image and a reference mass attenuation coefficient image of a material based on the reference images at different scan energies; and
determining the priori material density image based on the reference linear attenuation coefficient image and the reference mass attenuation coefficient image of the material.

In an embodiment, the material includes at least two components, the at least two components include a first component and a second component, and determining the priori material density image based on the reference linear attenuation coefficient image and the reference mass attenuation coefficient image of the material includes:
determining a priori material density image of the first component based on the reference linear attenuation coefficient image and a reference mass attenuation coefficient image of the first component; and
determining a priori material density image of the second component based on the reference linear attenuation coefficient image, the reference mass attenuation coefficient image of the first component, a reference mass attenuation coefficient image of the second component, and a density of the first component.

In an embodiment, the material includes at least two of water, iodine, calcium or uric acid.

In an embodiment, the first component is water and the second component is iodine, and determining the prior material density image based on the reference linear attenuation coefficient image and the reference mass attenuation coefficient image of the material includes:
determining a priori material density image of water based on the reference linear attenuation coefficient image and a reference mass attenuation coefficient image of water; and
determining a priori material density image of iodine based on the reference linear attenuation coefficient image, the reference mass attenuation coefficient image of water, a reference mass attenuation coefficient image of iodine, and a density of water.

In an embodiment, determining the prior material density image of water based on the reference linear attenuation coefficient image and the reference mass attenuation coefficient image of water includes:
obtaining a water coefficient ratio of a reference linear attenuation coefficient of each pixel to a reference mass attenuation coefficient of water based on the reference linear attenuation coefficient image and the reference mass attenuation coefficient image of water;
comparing the water coefficient ratio of each pixel with a preset threshold, setting the water coefficient ratio that is greater than the preset threshold to be equal to the preset threshold, and performing noise restoration on the water coefficient ratio greater than the preset threshold; and
obtaining the prior material density image of water based on the water coefficient ratio that is less than or equal to the preset threshold and the water coefficient ratio obtained after noise restoration.

In an embodiment, determining the priori material density image of iodine based on the reference linear attenuation coefficient image, the reference mass attenuation coefficient image of water, the reference mass attenuation coefficient image of iodine, and the density of water includes:
determining a part of an attenuation coefficient in an attenuation coefficient image contributed by iodine based on the reference linear attenuation coefficient image, the reference mass attenuation coefficient image of water, and the density of water;
obtaining an iodine coefficient ratio of a linear attenuation coefficient of each pixel to a reference mass attenuation coefficient of iodine based on the attenuation coefficient image of iodine and the reference mass attenuation coefficient image of iodine; and
obtaining the priori material density image of iodine based on the iodine coefficient ratio of each pixel.

In an embodiment, obtaining the prior material density image of iodine based on the iodine coefficient ratio of each pixel includes:
performing sign processing on the iodine coefficient ratio of each pixel to obtain an iodine coefficient ratio of each pixel after sign processing; and
obtaining the priori material density image of iodine based on the iodine coefficient ratio of each pixel after sign processing.

In an embodiment, obtaining the target material density image by solving the iterative decomposition function includes:
inputting an initial material density image into the iterative decomposition function for iterative updating until an iteration stop condition is met to obtain the target material density image, the iterative decomposition function including a fidelity term and a regularization term, the fidelity term representing a difference between a linear attenuation coefficient image corresponding to the material density image and a linear attenuation coefficient image of the scanned image, and the regularization term being configured to correct an intermediate material density image output by the fidelity term.

In an embodiment, the regularization term includes a first regularization term for smoothing and denoising the material density image, and a second regularization term for representing a difference between the material density image and the priori material density image.

In a second aspect, the present disclosure further provides another image iterative decomposition method, including:
obtaining scanned images of an object to be examined at different scan energies;
determining a priori material density image based on linear attenuation coefficient images at different scan energies;
constructing an iterative decomposition function based on the scanned images and the prior material density image, the iterative decomposition function being configured to perform noise reduction and material decomposition on the scanned images; and
obtaining a target material density image by solving the iterative decomposition function.

In an embodiment, after obtaining the scanned images of the object to be examined at different scan energies, the method further includes: determining a noise model based on the scanned images of the object to be examined at different scan energies, the noise model representing noise distribution information of each scanned image. Constructing the iterative decomposition function based on the scanned images and the prior material density image includes: determining the iterative decomposition function based on the scanned images, the noise model, and the prior material density image.

In an embodiment, determining the noise model based on the scanned images of the object to be examined at different scan energies includes: for each scanned image at each scan energy, obtaining a noise distribution image of each scanned image, the noise distribution image representing a noise level of each pixel in each scanned image; and determining the noise model based on the noise distribution image of each scanned image.

In a third aspect, the present disclosure further provides an image iterative decomposition apparatus, including:
a noise model module configured to determine a noise model based on scanned images of an object to be examined at different scan energies, the noise model representing noise distribution information of each scanned image;
a priori image module configured to determine a priori material density image based on reference images at different scan energies; and
a material density module configured to construct an iterative decomposition function based on the scanned images, the noise model, and the prior material density image; and obtain a target material density image by solving the iterative decomposition function, the iterative decomposition function being configured to perform noise reduction and material decomposition on the scanned images.

In a fourth aspect, the present disclosure further provides a computer device, including a memory and a processor. The memory stores a computer program, and the processor, when executing the computer program, implements steps of any image iterative decomposition method described above.

In a fifth aspect, the present disclosure further provides a non-transitory computer-readable storage medium having a computer program stored therein. When the computer program is executed by a processor, steps of any image iterative decomposition method described above are implemented.

In a sixth aspect, the present disclosure further provides a computer program product, including a computer program. When the computer program is executed by a processor, steps of any image iterative decomposition method described above are implemented.

One or more embodiments of the present disclosure will be described in detail below with reference to drawings. Other features, objects and advantages of the present disclosure will become more apparent from the description, drawings, and claims.

### BRIEF DESCRIPTION OF THE DRAWINGS

In order to describe the technical solutions of the embodiments of the present disclosure more clearly, the accompanying drawings required for describing the embodiments or for describing the conventional art will be briefly introduced as follows. Apparently, the accompanying drawings, in the following description, illustrate merely some embodiments of the present disclosure, for a person of ordinary skill in the art, other drawings can also be obtained according to these accompanying drawings without making any creative efforts.

FIG. 1 is a diagram showing an internal configuration of a computer device in an embodiment.

FIG. 2 is a schematic flow chart of an iterative image decomposition method in an embodiment.

FIG. 3 is a schematic flow chart of an iterative image decomposition method in another embodiment.

FIG. 4 is a schematic flow chart of determining a noise model in an embodiment.

FIG. 5 is a schematic flow chart of determining a priori material density image in an embodiment.

FIG. 6 is a schematic flow chart of determining a priori material density image in another embodiment.

FIG. 7 is a schematic flow chart of determining a priori material density image of water in an embodiment.

FIG. 8 is a schematic flow chart of determining a priori material density image of iodine in an embodiment.

FIG. 9 is a diagram showing a process of obtaining a target material density image of water in an embodiment.

FIG. 10 is a diagram showing a process of obtaining a target material density image of iodine in an embodiment.

FIG. 11 is a diagram showing a process of obtaining a target material density image of water in another embodiment.

FIG. 12 is a diagram showing a process of obtaining a target material density image of iodine in another embodiment.

FIG. 13 is a schematic flow chart of an iterative image decomposition method in another embodiment.

FIG. 14 is a schematic flow chart of determining a priori material density image in another embodiment.

FIG. 15 is a block diagram showing a configuration of an image iterative decomposition apparatus in an embodiment.

### DETAILED DESCRIPTION OF THE EMBODIMENTS

In order to make the objectives, technical solutions and advantages of the present disclosure more clearly understood, the present disclosure will be further described in detail with the accompanying drawings and embodiments. It should be understood that the specific embodiments described herein are only used to explain the present disclosure and not to limit the present disclosure.

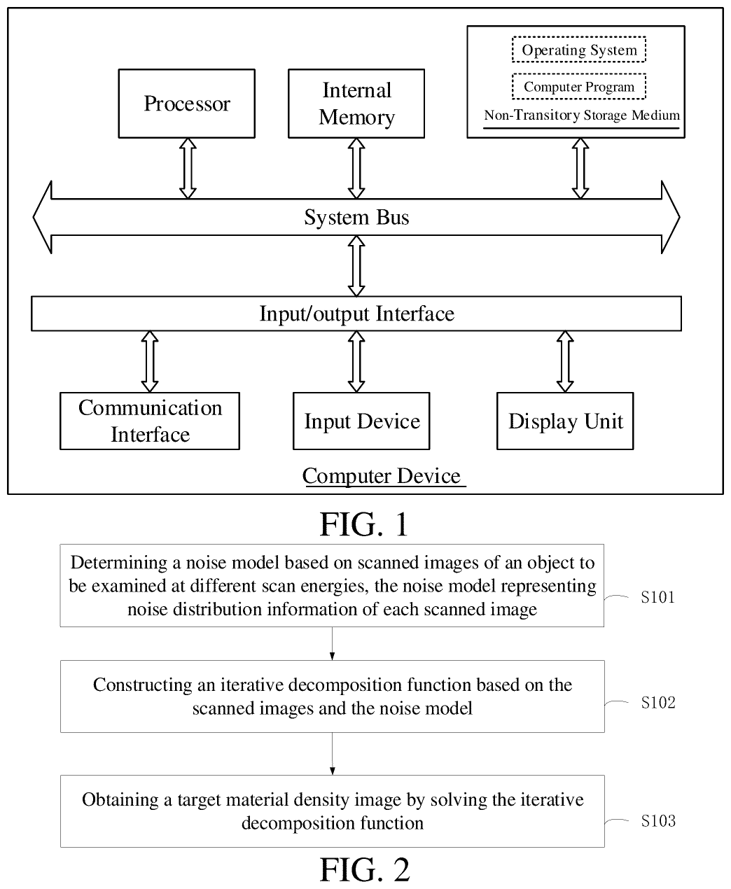

An image iterative decomposition method according to an embodiment of the present disclosure can be applied to a computer device as shown in FIG. 1, which can be a terminal. The computer device includes a processor, a memory, a communication interface, a display screen, and an input device connected via a system bus. The processor of the computer device is configured to provide computing and control capabilities. The memory of the computer device includes a non-transitory storage medium and an internal memory. The non-transitory storage medium stores operating systems and computer programs. The internal memory provides an environment for the operation of the operating systems and the computer programs in the non-transitory storage medium. The communication interface of the computer device is configured to communicate with external terminals in wired or wireless mode, which can be realized by WIFI, mobile cellular network, near field communication (NFC) or other technologies. The computer programs are executed by the processor in order to implement the image iterative decomposition method. The display screen of the computer device may be an LCD or e-ink display, and the input device of the computer device may be a touch layer covered by the display screen, or a key, trackball or trackpad set on the housing of the computer device, or an external keyboard, trackpad or mouse, etc.

It should be understood by a person of ordinary skill in the art that the configuration illustrated in FIG. 1 is only a block diagram of part of the configuration related to the solution of the present disclosure, and does not constitute a limitation on the computer device to which the solution of the present disclosure is applied. Specifically, the computer device may include more or less components than those shown in the figure, or may combine some components, or may have a different arrangement of components.

In an embodiment, as shown in FIG. 2, an image iterative decomposition method is provided, which is described by taking the method applied to the computer device in FIG. 1 as an example, the method includes: S101, determining a noise model based on scanned images of an object to be examined at different scan energies, the noise model representing noise distribution information of each scanned image; S102, constructing an iterative decomposition function based on the scanned images and the noise model, the iterative decomposition function being configured to perform noise reduction and material decomposition on the scanned images; and S103, obtaining a target material density image by solving the iterative decomposition function.

In this embodiment of the present disclosure, the noise model is determined based on the scanned images of the object to be examined at different scan energies, and the iterative decomposition function is constructed based on the scanned images and the noise model, so that the target material density image is obtained by solving the iterative decomposition function. The noise model represents the noise distribution information of each scanned image, the iterative decomposition function is configured to perform noise reduction and material decomposition on the scanned images, and the noise model is configured to balance the degree of noise reduction of each pixel in each scanned image. In the method described above, the noise model is configured to achieve different degrees of noise reduction for regions with different noise levels in the scanned image, thereby improving the uniformity of noise reduction.

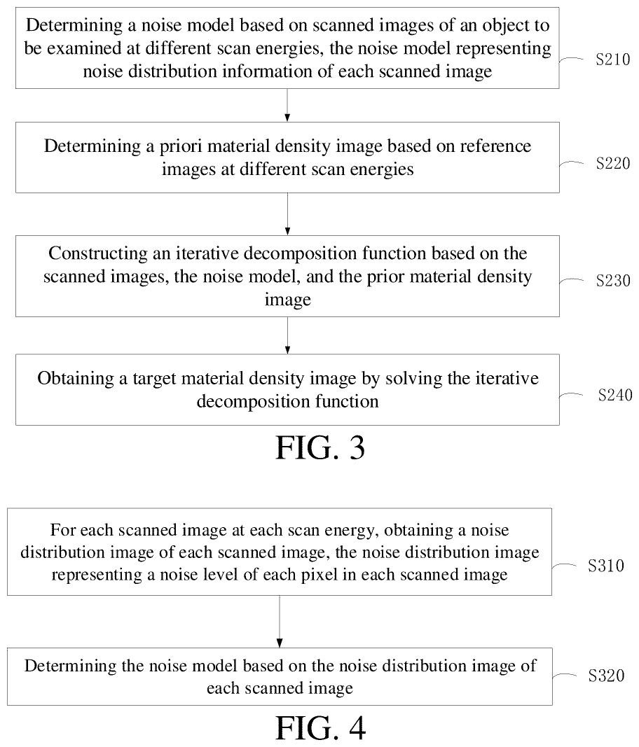

In an embodiment, as shown in FIG. 3, an image iterative decomposition method is provided, which is described by taking the method applied to the computer device in FIG. 1 as an example, the method includes the following steps.

In the step S210, a noise model is determined based on scanned images of an object to be examined at different scan energies. The noise model represents noise distribution information of each scanned image.

The scanned image is a CT image reconstructed from scanned data detected by a detector after the radiation beam emitted by a radiation scanning source is attenuated by the object to be examined. The scanning images at different scan energies refer to scanning images formed from scanning data obtained under radiation beams of different energies or different energy spectra. For example, the scan energies include low energy (e.g., 80 kVp), medium energy (e.g., 120 kVp), high energy (e.g., 140 kVp or higher), dual energy, and multi-energy. For conventional CT, two different energies (such as 80 kVp and 140 kVp) are used for scanning simultaneously. Other common combinations include 60 kVp/70 kVp/100 kVp and 140 kVp/150 kVp. For photon counting CT, the photon energy is generally divided into 2 to 5 energy bins, which are then freely combined into different scan energies.

It should be noted that the noise distribution on the scanned image is uneven, with some regions having high noise and some regions having low noise. The noise model represents the noise distribution information of each scanned image.

Optionally, for the scanned image at each scan energy, the computer device can determine noise distribution information of the scanned image based on the scanned image, and form a noise model corresponding to the noise distribution information.

In the step S220, a priori material density image is determined based on reference images at different scan energies.

The reference images are scanned images that meet a quality requirement. The material density image is a density distribution image of a base material in the scanned image.

Optionally, the computer device may perform quality assessment on the scanned image of the object to be examined in advance, and take the scanned image that meets the quality requirement as the reference image of the object to be examined, so as to determine the material density image based on the reference images at different scan energies as the priori material density image.

Exemplarily, the computer device may obtain signal-to-noise ratios of the scanned images, and compare the signal-to-noise ratios with a preset signal-to-noise ratio, respectively, to determine the scanned images having a signal-to-noise ratio greater than the preset signal-to-noise ratio as the reference images that meet the quality requirement, and then input the reference images into a material density image generation model to generate a material density image of the reference images, i.e., the priori material density image.

It should be noted that the scanned images taken as the reference images may be the scanned images for which the noise model is determined in the step S210 described above, or may be other scanned images acquired in advance.

In the step S230, an iterative decomposition function is constructed based on the scanned images, the noise model, and the prior material density image.

In the step S240, a target material density image is obtained by solving the iterative decomposition function. The iterative decomposition function is configured to perform noise reduction and material decomposition on the scanned images, and the noise model is configured to balance a degree of noise reduction of each pixel in each scanned image.

The iterative decomposition function is an iterative function that represents a correlation between the scanned images, the noise model, the prior material density image, the material density image and the degree of noise reduction, and is configured to achieve noise reduction and material decomposition for the scanned images. The noise model can be configured to correct the degree of noise reduction in the iterative decomposition function to balance the degree of noise reduction of each pixel in the scanned image, thereby balancing the overall noise reduction effect of the image.

Optionally, after obtaining the scanning images at different scan energies, the noise model, and the prior material density image corresponding to the reference images, the computer device may construct the iterative decomposition function based on the scanning images at different scan energies, the noise model, and the prior material density image corresponding to the reference images to iteratively update the material density image, and the iterative decomposition function may perform noise reduction and material decomposition on the scanning images to obtain the target material density image that is finally output by the iterative decomposition function.

In this embodiment of the present disclosure, the noise model is determined based on the scanned images of the object to be examined at different scan energies, and the priori material density image is determined based on the reference images at different scan energies, and then the iterative decomposition function is constructed based on the scanned images, the noise model, and the prior material density image, so that the target material density image is obtained by solving the iterative decomposition function. The noise model represents the noise distribution information of each scanned image, the iterative decomposition function is configured to perform noise reduction and material decomposition on the scanned images, and the noise model is configured to balance the degree of noise reduction of each pixel in each scanned image. In the method described above, the noise model is configured to achieve different degrees of noise reduction for regions with different noise levels in the scanned image, thereby improving the uniformity of noise reduction. Meanwhile, the prior material density image of the reference images is taken as a priori constraint in the iteration process to reduce the negative impact of the noise reduction, thereby improving the quality of the target material density image.

The noise distribution information of the scanned image includes a noise level of each pixel. In an embodiment, as shown in FIG. 4, the above step S210 of determining the noise model based on the scanned images of the object to be examined at different scan energies includes:

In the step S310, a noise distribution image of each scanned image at each scan energy is obtained. The noise distribution image represents a noise level of each pixel in each scanned image.

The noise level can be represented by a noise grade. The higher the noise grade, the higher the noise level.

Optionally, for the scanned image at each scan energy, the computer device may input the scanned image into a noise level model, and perform noise identification and level classification on the scanned image through the noise level model, so as to obtain the noise level of each pixel in the scanned image, and mark the scanned image with the noise level of each pixel to form an image that serves as the noise distribution image of the scanned image.

In the step S320, the noise model is determined based on the noise distribution image of each scanned image.

Optionally, after obtaining the noise distribution image of the scanned image, the computer device may directly take the noise distribution image of the scanned image as the noise model of the scanned image.

Exemplarily, when different scan energies include high scan energy E₁ and low scan energy E₂, the scanned images at different scan energies correspondingly include E₁(r) and E₂(r), and the noise model N(r) is denoted as follows:

$$N ( r ) = [ \begin{matrix}N ( {E}_{1} ( r ) ) \\ N ( {E}_{2} ( r ) )\end{matrix} ]$$

An initial fidelity weight λ₀ is generally used in the iterative decomposition function to perform noise reduction on each pixel in the scanned image to the same degree. The noise model N(r) can correct the fidelity weight λ to achieve a balance in the degree of noise reduction on each pixel in the scanned image. A corrected fidelity weight of the scanned image is denoted as λ/(r).

The noise model N(r) represents the noise level of each pixel r in the scanned image. The greater the noise level, the lower the corrected fidelity weight, and the greater the noise reduction achieved, conversely, the lower the noise level, the greater the corrected fidelity weight, and the lower the noise reduction achieved.

In this embodiment of the present disclosure, for the scanned image at each scan energy, the noise distribution image of the scanned image is obtained to determine the noise model based on the noise distribution image of the scanned image. The noise distribution image represents the noise level of each pixel in the scanned image. In the method described above, the noise model can be configured to reflect the actual noise level in the scanned image. The degree of noise reduction is balanced based on the noise model, and different degrees of noise reduction are achieved in regions with different noise levels, which makes the overall noise reduction efficiency of the image uniform, thereby improving the image quality.

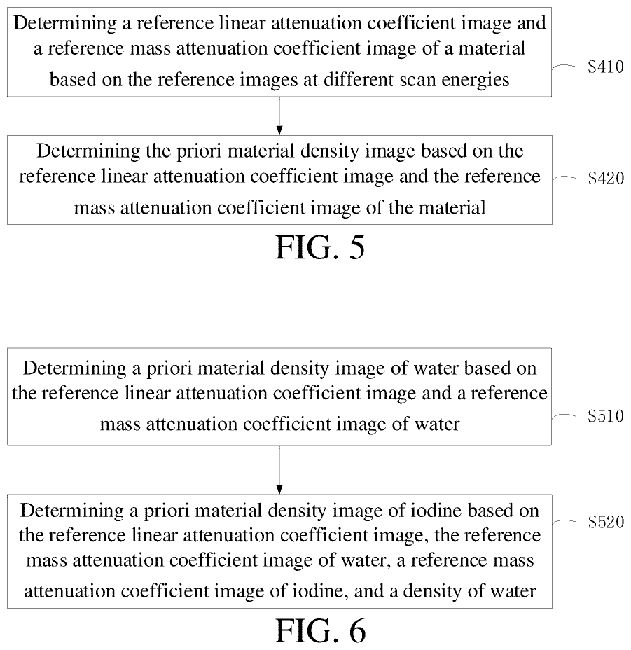

The prior material density image can be obtained based on a reference linear attenuation coefficient image of the reference images, and a reference mass attenuation coefficient image of a corresponding material. Based on this, in an embodiment, as shown in FIG. 5, the above step S220 of determining the prior material density image based on the reference images at different scan energies includes:

In the step S410, a reference linear attenuation coefficient image and a reference mass attenuation coefficient image of a material are determined based on the reference images at different scan energies.

The material may also be referred to as a base material, which is the component of the object to be examined. Exemplarily, the material may include at least one of water, iodine, calcium, or uric acid.

Optionally, for the reference image at each scan energy, the computer device can use a conversion relationship between a CT value and a linear attenuation coefficient to determine a linear attenuation coefficient of each pixel in the reference image, and the linear attenuation coefficients of all pixels form a linear attenuation coefficient image of the reference image. The linear attenuation coefficient images corresponding to different scan energies are then weighted to obtain the reference linear attenuation coefficient image.

Optionally, after obtaining the above reference linear attenuation coefficient image, the computer device can form the reference mass attenuation coefficient image of the material corresponding to the reference image based on the reference linear attenuation coefficient image and a known mass attenuation coefficient of the material to be detected. The mass attenuation coefficient of the material to be detected is determined based on a calibration phantom.

In the step S420, the priori material density image is determined based on the reference linear attenuation coefficient image and the reference mass attenuation coefficient image of the material.

Optionally, for each material, the computer device can obtain a linear attenuation coefficient of each pixel based on the reference linear attenuation coefficient image, obtain a mass attenuation coefficient of each pixel based on the reference mass attenuation coefficient image of the material, and then obtain the prior material density image based on a ratio of the linear attenuation coefficient to the mass attenuation coefficient of each pixel.

Exemplarily, when the material includes a first component and a second component, the prior material density image P(r) is denoted as follows:

$$P ( r ) = [ \begin{matrix}\overline{μ} / {ϕ}_{1} \\ \overline{μ} / {ϕ}_{2}\end{matrix} ]$$

where μ̅ represents the reference linear attenuation coefficient image, ϕ₁ represents the reference mass attenuation coefficient image of the first component, and ϕ₂ represents the reference mass attenuation coefficient image of the second component. The above expression of P(r) is also referred to as a process of linearly scaling the linear attenuation value to the corresponding material density image.

In this embodiment of the present disclosure, the reference linear attenuation coefficient image and the reference mass attenuation coefficient image of the material are determined based on the reference images at different scan energies, and thus the priori material density image is determined based on the reference linear attenuation coefficient image and the reference mass attenuation coefficient image of the material. In the method described above, the priori material density image determined based on the reference images that meet the quality requirement is taken as a priori constraint in the iterative decomposition function to achieve the restoration for the structure of the image, thereby improving the fidelity of the obtained target material density image.

The material includes at least two components. In an embodiment, the material includes at least two of water, iodine, calcium, or uric acid. It can be understood that the present disclosure is not limited to the type of material, and the material may further include other components, such as fat, hydroxyapatite, etc. In a case that the material includes two components, as an example, the two components can be a water-iodine material pair, a water-calcium material pair, or a calcium-uric acid material pair. It can be understood that the present disclosure does not exhaustively list all material pairs. The above step S420 of determining the priori material density image based on the reference linear attenuation coefficient image and the reference mass attenuation coefficient image of the material includes: determining a prior material density image of the first component based on the reference linear attenuation coefficient image and a reference mass attenuation coefficient image of the first component; and determining a prior material density image of the second component based on the reference linear attenuation coefficient image, the reference mass attenuation coefficient image of the first component, a reference mass attenuation coefficient image of the second component, and a density of the first component.

In an embodiment, taking the first component as water and the second component as iodine as an example, as shown in FIG. 6, the above step S420 of determining the prior material density image based on the reference linear attenuation coefficient image and the reference mass attenuation coefficient image of the material includes:

In the step S510, a priori material density image of water is determined based on the reference linear attenuation coefficient image and a reference mass attenuation coefficient image of water.

Optionally, for water, the computer device may, based on a preset calculation relationship between the reference linear attenuation coefficient image, the reference mass attenuation coefficient image of water, and the priori material density image of water, substitute the reference linear attenuation coefficient image and the reference mass attenuation coefficient image of water into the above calculation relationship to obtain the prior material density image of water.

In the step S520, a priori material density image of iodine is determined based on the reference linear attenuation coefficient image, the reference mass attenuation coefficient image of water, a reference mass attenuation coefficient image of iodine, and a density of water.

Optionally, for iodine, the computer device may, based on a preset calculation relationship between the reference linear attenuation coefficient image, the reference mass attenuation coefficient image of water, the reference mass attenuation coefficient image of iodine, the density of water, and the prior material density image of iodine, substitute the reference linear attenuation coefficient image, the reference mass attenuation coefficient image of water, the reference mass attenuation coefficient image of iodine, and the density of water into the above calculation relationship to obtain the prior material density image of iodine.

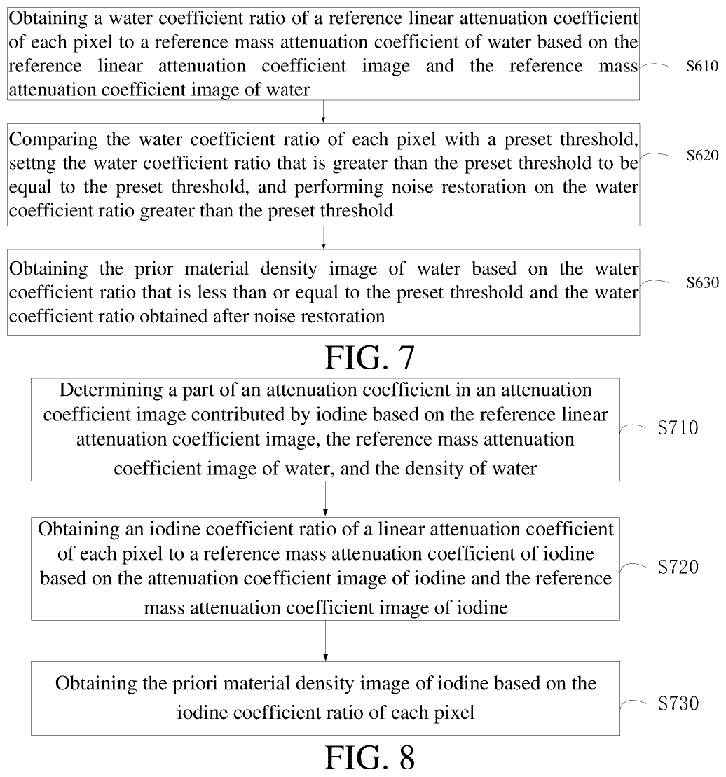

In an optional embodiment, as shown in FIG. 7, the above step S510 of determining the prior material density image of water based on the reference linear attenuation coefficient image and the reference mass attenuation coefficient image of water includes:

In the step S610, a water coefficient ratio of a reference linear attenuation coefficient of each pixel to a reference mass attenuation coefficient of water is obtained based on the reference linear attenuation coefficient image and the reference mass attenuation coefficient image of water.

The reference linear attenuation coefficient image includes the linear attenuation coefficient of each pixel in the corresponding reference image, and the reference mass attenuation coefficient image includes the mass attenuation coefficient of each pixel in the corresponding reference image.

Optionally, for each pixel in the reference image, the computer device can obtain a ratio of the reference linear attenuation coefficient of each pixel to the reference mass attenuation coefficient of water based on the reference linear attenuation coefficient image and the reference mass attenuation coefficient image of water as the water coefficient ratio. Exemplarily, the reference linear attenuation coefficient image is denoted as μ̅(r), the reference mass attenuation coefficient image of water is denoted as ϕ₁, and thus the water coefficient ratio is denoted as μ̅(r)/ϕ₁.

In the step S620, the water coefficient ratio of each pixel is compared with a preset threshold, the water coefficient ratio that is greater than the preset threshold is set to be equal to the preset threshold, and noise restoration is performed on the water coefficient ratio greater than the preset threshold.

The noise restoration is configured to improve the consistency between the noise distribution in the obtained water prior material density image and the actual noise distribution in the reference image.

Optionally, the computer device may compare the water coefficient ratio of each pixel with the preset threshold to perform a corresponding processing on the water coefficient ratio of each pixel based on a comparison result. The water coefficient ratio that is less than or equal to the preset threshold is retained, the water coefficient ratio that is greater than the preset threshold is set to be equal to the preset threshold, and the noise restoration is performed on the water coefficient ratio that is greater than the preset threshold.

Exemplarily, the noise restoration may be achieved by generating a noise mask based on the actual noise distribution of the reference image. The computer device can obtain the noise distribution of the reference image in advance to form a noise model image, remove a pixel region in the noise model image whose corresponding water coefficient ratio is less than or equal to the preset threshold, and retain a pixel region whose corresponding water coefficient ratio is greater than the preset threshold, so as to form the noise mask.

In the step S630, the priori material density image of water is obtained based on the water coefficient ratio that is less than or equal to the preset threshold and the water coefficient ratio obtained after noise restoration.

Optionally, the computer device may summarize the water coefficient ratios that are less than or equal to the preset threshold, and the water coefficient ratios obtained after noise restoration to form the priori material density image of water.

Exemplarily, the process of determining the prior material density image P₁(r) of water can be represented by the following formula:

$${P}_{1} ( r ) = min ( \overline{μ} ( r ) / {ϕ}_{1} , 1000 ) + N ( mask )$$

where 1000 represents the preset threshold, and N(mask) represents the noise mask.

In an optional embodiment, as shown in FIG. 8, the above step S520 of determining the priori material density image of iodine based on the reference linear attenuation coefficient image, the reference mass attenuation coefficient image of water, the reference mass attenuation coefficient image of iodine, and the density of water includes:

In the step S710, a part of an attenuation coefficient in an attenuation coefficient image contributed by iodine is determined based on the reference linear attenuation coefficient image, the reference mass attenuation coefficient image of water, and the density of water.

The reference linear attenuation coefficient image is a reference linear attenuation coefficient image obtained under the combined action of water and iodine.

Optionally, the computer device may determine a linear attenuation coefficient image contributed by water based on the reference mass attenuation coefficient image of water and the density of water, and obtain a linear attenuation coefficient image contributed by iodine by subtracting the linear attenuation coefficient image contributed by water from the reference linear attenuation coefficient image. Exemplarily, the reference linear attenuation coefficient image is denoted as μ̅(r), the reference mass attenuation coefficient image of water is denoted as ϕ₁, the density of water is 1000 mg/ml, the linear attenuation coefficient image contributed by water is denoted as ϕ₁*1000, and thus the linear attenuation coefficient image contributed by iodine is denoted as μ̅(r)−ϕ₁*1000.

In the step S720, an iodine coefficient ratio of a linear attenuation coefficient of each pixel to a reference mass attenuation coefficient of iodine is obtained based on the attenuation coefficient image of iodine and the reference mass attenuation coefficient image of iodine.

Optionally, for each pixel in the reference image, the computer device can obtain a ratio of the linear attenuation coefficient of each pixel to the reference mass attenuation coefficient of iodine based on the linear attenuation coefficient image of iodine and the reference mass attenuation coefficient image of iodine as the iodine coefficient ratio. Exemplarily, the linear attenuation coefficient image of iodine is denoted as μ̅(r)−ϕ₁*1000, the reference mass attenuation coefficient image of iodine is denoted as ϕ₂, and the iodine coefficient ratio is denoted as (μ̅(r)−ϕ₁*1000)/ϕ₂.

In the step S730, the priori material density image of iodine is obtained based on the iodine coefficient ratio of each pixel.

Optionally, after obtaining the iodine coefficient ratio of each pixel, the computer may perform sign processing on the iodine coefficient ratio of each pixel, and form the priori material density image of iodine based on the iodine coefficient ratio of each pixel after the sign processing. The sign processing is determined based on the linear attenuation coefficient image μ̅(r)−ϕ₁*1000 of iodine. If a value of μ̅(r)−ϕ₁*1000 is greater than 0, the iodine coefficient ratio is positive. If a value of μ̅(r)−ϕ₁*1000 is less than 0, the iodine coefficient ratio is negative. If a value of μ̅(r)−ϕ₁*1000 is equal to 0, the iodine coefficient ratio is 0.

Exemplarily, the process of determining the prior material density image P₂(r) of iodine can be represented by the following formula:

$${P}_{2} ( r ) = [ ( \overline{μ} ( r ) - {ϕ}_{1} * 10 \; 00 ) / {ϕ}_{2} ] * sign ( \overline{μ} ( r ) - {ϕ}_{1} * 1000 )$$

where 1000 represents 1000 mg/ml, which is the density of water, and sign(x) represents the sign processing.

In this embodiment of the present disclosure, when the material includes water and iodine, the prior material density image of water is determined based on the reference linear attenuation coefficient image and the reference mass attenuation coefficient image of water, and the prior material density image of iodine is determined based on the reference linear attenuation coefficient image, the reference mass attenuation coefficient image of water, the reference mass attenuation coefficient image of iodine and the density of water. In the method described above, the acquisition of the prior material density image of water and the prior material density image of iodine is achieved, which improves the consistency between the noise distribution in the obtained prior material density image and the actual noise distribution in the reference image, and facilitates improving the fidelity of the final target material density image without introducing erroneous information.

When the material pair is water and calcium, it can be understood that the method for determining the prior material density image of water does not need to be described repeatedly, and the method for determining the prior material density image of calcium is similar to the method for determining the prior material density image of iodine in the above embodiment. Specifically, a attenuation coefficient image contributed by calcium can be determined based on the reference linear attenuation coefficient image, the reference mass attenuation coefficient image of water and the density of water, and then a calcium coefficient ratio of a linear attenuation coefficient of each pixel to a reference mass attenuation coefficient of calcium can be obtained based on the attenuation coefficient image contributed by calcium and a reference mass attenuation coefficient image of calcium, so as to obtain a prior material density image of calcium based on the calcium coefficient ratio of each pixel.

When the material pair is calcium and uric acid, the method for determining the prior material density image of calcium and the prior material density image of uric acid can also refer to the method for determining the prior material density image of water and the prior material density image of iodine in the above embodiment, which will not be repeated here.

It should be noted that, when the material includes more than two components, the method for determining the prior material density images of these components can be derived from the method for determining the prior material density images of the material pair.

The target material density image can be obtained by iteratively updating the material density image through the iterative decomposition function until an iteration stop condition is met. In an embodiment, the above S240 of obtaining the target material density image by solving the iterative decomposition function includes: inputting an initial material density image into the iterative decomposition function for iterative updating until an iteration stop condition is met to obtain the target material density image. The iterative decomposition function includes a fidelity term and a regularization term. The fidelity term represents a difference between a linear attenuation coefficient image corresponding to the material density image and a linear attenuation coefficient image of the scanned image, and the regularization term is configured to correct an intermediate material density image output by the fidelity term.

Optionally, the computer device may use the noise model to balance the degree of noise reduction on the difference between the linear attenuation coefficient image corresponding to the material density image and the linear attenuation coefficient image of the scanned image to form the fidelity term, and use the prior material density image to correct the intermediate material density image output by the fidelity term to form the regularization term, thereby constructing the iterative decomposition function, and then input the above scanned images, the noise model, the prior material density image, and the initial material density image into the iterative decomposition function to iteratively update the material density image, thereby obtaining the target material density image.

Exemplarily, the iterative decomposition function is denoted as follows:

$$M = arg min λ {\sum }_{r} {‖ μ ( r ) - Φ * M ( r ) ‖}_{{N}^{- 1}}^{2} + T V$$

where λ∥μ(r)−ϕ*M(r)∥_{N}_{^{−1}}² represents the fidelity term, N represents the noise model, and λ represents the fidelity weight. μ(r) represents the linear attenuation coefficient corresponding to the scanned images of the object to be examined at different scan energies, and ϕ represents a decomposition matrix formed by the mass attenuation coefficient images of different materials corresponding to the calibration phantom at different scan energies. M(r) represents the material density image. TV represents the regularization term. ϕ*M(r) represents the linear attenuation coefficient image corresponding to the material density image.

Optionally, for the scanned image at each scan energy, the computer device can use a conversion relationship between a CT value and a linear attenuation coefficient to determine a linear attenuation coefficient of each pixel in the scanned image, and the linear attenuation coefficients of all pixels form a linear attenuation coefficient image μ(r) of the scanned image.

Exemplarily, when different scan energies include high scan energy E₁ and low scan energy E₂, the linear attenuation coefficient images μ(r) corresponding to different scan energies are denoted as follows:

$$μ ( r ) = [ \begin{matrix}μ ( {E}_{1} ( r ) ) \\ μ ( {E}_{2} ( r ) )\end{matrix} ]$$

The calibration phantom is a reference body with the same concentration of the material to be detected as that in the object to be examined.

Optionally, the computer device can obtain phantom images of the calibration phantom at different scan energies, and for the phantom image at each scan energy, the linear attenuation coefficient of each pixel r in the phantom image can be determined by using a conversion relationship between a CT value and a linear attenuation coefficient to form a linear attenuation coefficient image. The mass attenuation coefficient image of the corresponding material is obtained based on a ratio of the linear attenuation coefficient of each pixel point r in the linear attenuation coefficient image to the known mass attenuation coefficient of the material to be detected. The mass attenuation coefficient images of the material to be detected corresponding to the phantom images at all scanning energies form the decomposition matrix ϕ.

Exemplarily, when different scan energies include high scan energy E₁ and low scan energy E₂, and the material includes the first component and the second component, the decomposition matrix is denoted as follows:

$$ϕ = [ \begin{matrix}{ϕ}_{1} ( {E}_{1} ) & {ϕ}_{2} ( {E}_{1} ) \\ {ϕ}_{1} ( {E}_{2} ) & {ϕ}_{2} ( {E}_{2} )\end{matrix} ]$$

When the above iterative decomposition function performs the first iteration, the input material density image M(r) is the initial material density image determined by the decomposition matrix ϕ and the linear attenuation coefficient image of the phantom image, and the subsequent input M(r) is a candidate material density image output by each iteration of the iterative decomposition function until the iteration stop condition is met, then the iteration is stopped. The candidate material density image output by the last iteration is taken as the target material density image.

Exemplarily, the iteration stop condition may be that a number of iterations is greater than or equal to an upper limit, or that a similarity between the candidate material density image output by the current iteration and the candidate material density image output by the previous iteration is greater than or equal to a preset similarity, or that a difference between the candidate material density image output by the current iteration and the candidate material density image output by the previous iteration is less than or equal to a preset difference. The present embodiment does not specifically limit the iteration stop condition, and the setting can be adjusted based on an actual need.

In an embodiment, the regularization term includes a first regularization term for smoothing and denoising the material density image, and a second regularization term for representing a difference between the material density image and the priori material density image.

The first regularization term is configured to smooth and denoise the material density image, improving the overall smoothness of the image. The second regularization term is configured to restore the structure of the material density image, improving the fidelity of the image.

Optionally, the computer device can perform smoothing and denoising on the intermediate material density image output by the fidelity term through the first regularization term in the iterative decomposition function, and then perform structural restoration through the second regularization term, avoiding image distortion caused by excessive smoothing, so as to output the target material density image that takes into account overall smoothness and fidelity.

Exemplarily, the iterative decomposition function including the first regularization term and the second regularization term is denoted as follows:

$$M = arg min λ {\sum }_{r} {‖ μ ( r ) - Φ * M ( r ) ‖}_{{N}^{- 1}}^{2} + c * {‖ M ( r ) ‖}_{T V} + ( 1 - c ) * {‖ M ( r ) - P ( r ) ‖}_{T V}$$

∥M(r)∥_{TV} represents the first regularization term, ∥M(r)−P(r)∥_{TV} represents the second regularization term, P(r) represents the prior material density image, and parameter c∈[0,1], which is configured to balance the first regularization term and the second regularization term. Exemplarily, c is equal to 0.5.

In this embodiment of the present disclosure, the scanned images, the noise model, the prior material density image, and the initial material density image are input into the iterative decomposition function for iterative updating until the iteration stop condition is met to obtain the target material density image. The iterative decomposition function includes the fidelity term and the regularization term. The fidelity term represents the difference between the linear attenuation coefficient image corresponding to the material density image and the linear attenuation coefficient image corresponding to the scanned image, and the regularization term is configured to correct the intermediate material density image output by the fidelity term. The regularization term specifically includes the first regularization term for smoothing and denoising the material density image, and the second regularization term for representing the difference between the material density image and the priori material density image. In the method described above, the fidelity term in the iterative decomposition function is configured to achieve different degrees of noise reduction for regions with different noise levels in the scanned image, thereby improving the uniformity of noise reduction. Meanwhile, the first regularization term in the iterative decomposition function is used for smoothing and denoising, and the second regularization term in the iterative decomposition function is used for restoring the structure, so as to obtain the target material density image that takes into account both overall smoothness and fidelity, thereby improving the image quality.

In an embodiment, another image iterative decomposition method is provided, which is described by taking the method applied to the computer device in FIG. 1 as an example, the method includes: obtaining scanned images of an object to be examined at different scan energies; determining a priori material density image based on linear attenuation coefficient images at different scan energies; constructing an iterative decomposition function based on the scanned images and the prior material density image, the iterative decomposition function being configured to perform noise reduction and material decomposition on the scanned images; and obtaining a target material density image by solving the iterative decomposition function.

In this embodiment of the present disclosure, the priori material density image is determined based on the linear attenuation coefficient images at different scan energies, and the iterative decomposition function is constructed based on the scanned images and the prior material density image, so that the target material density image is obtained by solving the iterative decomposition function. The iterative decomposition function is configured to perform noise reduction and material decomposition on the scanned images. In the method described above, the prior material density image of the reference images is taken as a priori constraint in the iteration process to reduce the negative impact of the noise reduction, thereby improving the quality of the target material density image.

In an embodiment, after obtaining the scanned images of the object to be examined at different scan energies, the method further includes: determining a noise model based on the scanned images of the object to be examined at different scan energies. The noise model represents noise distribution information of each scanned image, and the noise model is configured to balance the degree of noise reduction of each pixel in each scanned image. For specific limitations of this embodiment can be referred to the description of the above step S210, which will not be repeated here.

Correspondingly, constructing the iterative decomposition function based on the scanned images and the prior material density image includes: determining the iterative decomposition function based on the scanned images, the noise model, and the prior material density image.

In this embodiment, the noise model is configured to achieve different degrees of noise reduction for regions with different noise levels in the scanned image, thereby improving the uniformity of noise reduction. Meanwhile, the prior material density image of the reference images is taken as a priori constraint in the iteration process to reduce the negative impact of the noise reduction, thereby improving the quality of the target material density image.

The method in the present disclosure is not limited to dual-material decomposition, but is also applicable to multi-material decomposition. For example, when the material includes three components, images of the object to be examined at three different scan energies can be obtained, and then the corresponding prior material density image can be obtained. Further, the decomposition matrix can be updated to a 3*3 matrix, and then the target material density image can be determined through the corresponding iterative decomposition function. In other words, for n components (n is generally 2 to 5), images of the object to be examined at n scan energies are obtained, and then the corresponding prior material density image is obtained. Further, the decomposition matrix is updated to an non matrix, and then the target material density image is determined through the corresponding iterative decomposition function.

Taking the above iterative decomposition function including the first regularization term and the second regularization term as an example, the beneficial effects of the target material density image of water and the target material density image of iodine obtained by the above method are described.

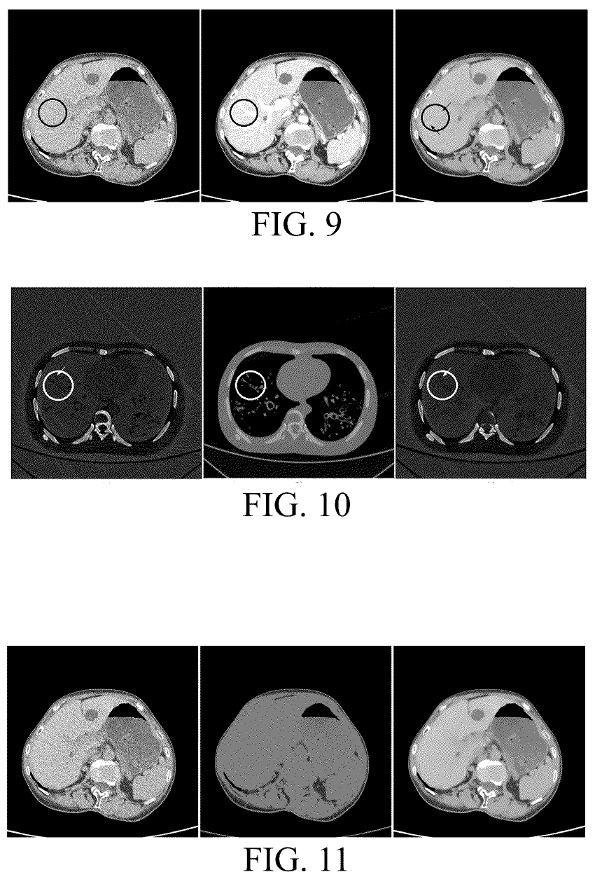

FIG. 9 is a diagram showing a process of obtaining a target material density image of water after noise reduction. From left to right, the first image is the candidate material density image of water output after the fidelity term and the first regularization term in the iterative decomposition function, the second image is the prior material density image of water obtained by the method of obtaining the prior material density image of the material described in the above step S420, and the third image is the target material density image of water obtained by iterating the decomposition function multiple times. It can be seen that since there is a region with different structures (circled region) between the first image and the second image, erroneous structural information (circled region) is introduced into the target material density image of water (i.e., the third image). FIG. 10 is a diagram showing a process of obtaining a target material density image of iodine in the same manner. Similar to the target material density image of water, erroneous structural information (circled region) is also introduced into the target material density image of iodine.

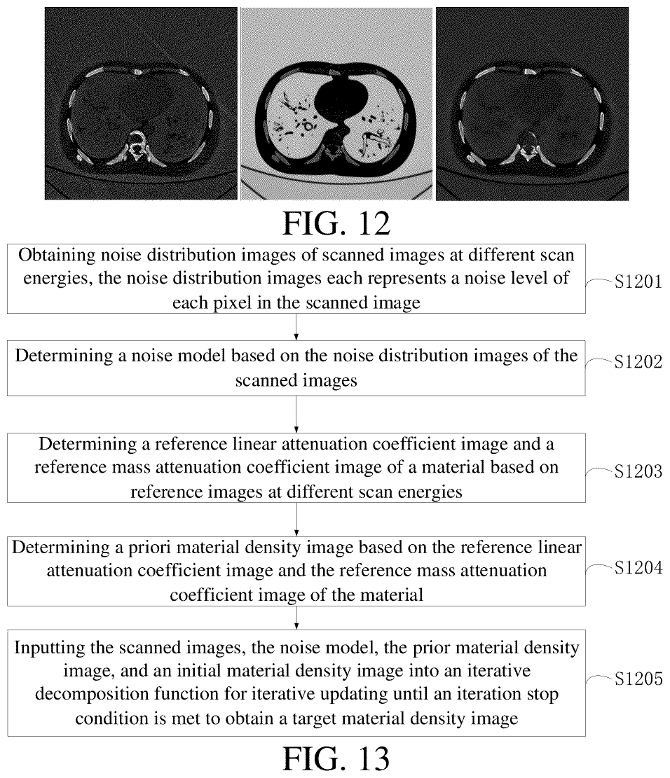

FIG. 11 is a diagram showing another process of obtaining a target material density image of water after noise reduction. From left to right, the first image is also the candidate material density image of water output after the fidelity term and the first regularization term in the iterative decomposition function, the second image is the prior material density image of water obtained by the method described in the above step S630, and the third image is the target material density image of water obtained by iterating the iterative decomposition function multiple times. It can be seen that since the structures between the first image and the second image are the same, no erroneous information is introduced, and there is no erroneous structural information in the target material density image of water accordingly. FIG. 12 is a diagram showing another process of obtaining a target material density image of iodine in the same manner. Similar to the target material density image of water, there is no erroneous structural information in the target material density image of iodine (i.e., the third image). Therefore, by using the image iterative decomposition method provided in the present disclosure, the material density image with accurate structure and high fidelity can be obtained.

To facilitate understanding by those skilled in the art, the image iterative decomposition method provided by the present disclosure is described in detail below. As shown in FIG. 13, the method may include the following steps.

In the step S1201, noise distribution images of scanned images at different scan energies are obtained. The noise distribution images each represents a noise level of each pixel in the scanned image.

In the step S1202, a noise model is determined based on the noise distribution images of the scanned images.

In the step S1203, a reference linear attenuation coefficient image and a reference mass attenuation coefficient image of a material are determined based on reference images at different scan energies.

In the step S1204, a priori material density image is determined based on the reference linear attenuation coefficient image and the reference mass attenuation coefficient image of the material.

In the step S1205, the scanned images, the noise model, the prior material density image, and an initial material density image are input into an iterative decomposition function for iterative updating until an iteration stop condition is met to obtain a target material density image. The iterative decomposition function includes a fidelity term and a regularization term. The fidelity term represents a difference between a linear attenuation coefficient image corresponding to the material density image and a linear attenuation coefficient image of the scanned image, and the regularization term is configured to correct an intermediate material density image output by the fidelity term. The regularization term includes a first regularization term for smoothing and denoising the material density image, and a second regularization term for representing a difference between the material density image and the prior material density image.

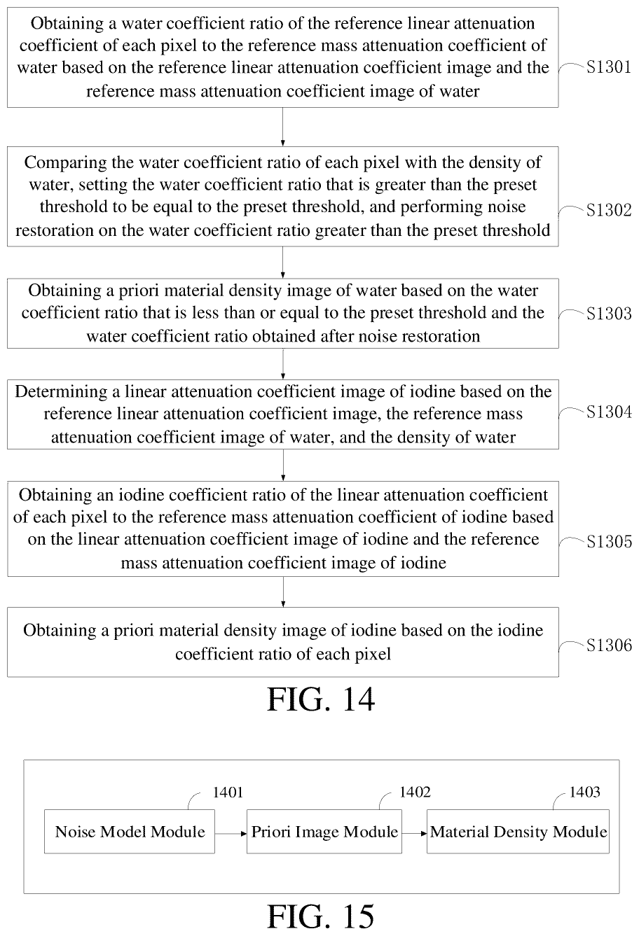

When the material includes water and iodine, as shown in FIG. 14, the above step S1204 of determining the prior material density image based on the reference linear attenuation coefficient image and the reference mass attenuation coefficient image of the material includes the following steps.

In the step S1301, a water coefficient ratio of the reference linear attenuation coefficient of each pixel to the reference mass attenuation coefficient of water is obtained based on the reference linear attenuation coefficient image and the reference mass attenuation coefficient image of water.

In the step S1302, the water coefficient ratio of each pixel is compared with the density of water, the water coefficient ratio that is greater than the preset threshold is set to be equal to the preset threshold, and noise restoration is performed on the water coefficient ratio greater than the preset threshold.

In the step S1303, a priori material density image of water is obtained based on the water coefficient ratio that is less than or equal to the preset threshold and the water coefficient ratio obtained after noise restoration.

In the step S1304, a linear attenuation coefficient image of iodine is determined based on the reference linear attenuation coefficient image, the reference mass attenuation coefficient image of water, and the density of water.

In the step S1305, an iodine coefficient ratio of the linear attenuation coefficient of each pixel to the reference mass attenuation coefficient of iodine is obtained based on the linear attenuation coefficient image of iodine and the reference mass attenuation coefficient image of iodine.

In the step S1306, a priori material density image of iodine is obtained based on the iodine coefficient ratio of each pixel.

It should be noted that, for the descriptions in the above steps S1201-S1205 and S1301-S1306, reference can be made to the relevant descriptions in the above embodiments, and the effects are similar, which will not be repeated in this embodiment.

It should be understood that although the individual steps in the flow charts involved in the embodiments as described above are shown sequentially as indicated by arrows, the steps are not necessarily performed sequentially in the order indicated by the arrows. Unless explicitly stated herein, the execution of these steps is not strictly limited in any order and these steps can be performed in any other order. Moreover, at least some of the steps in the flow charts involved in the embodiments as described above may include multiple sub-steps or multiple stages that are not necessarily performed simultaneously, but may be performed at different moments. The order in which these sub-steps or stages are performed is not necessarily sequential, and these sub-steps or stages may be performed in turn or alternately with at least some of other steps or at least some of sub-steps or stages in other steps.

Based on the same inventive concept, embodiments of the present disclosure also provide an image iterative decomposition apparatus for implementing the image iterative decomposition method as described above. The solution to the problem provided by the apparatus is similar to the implementation of the method documented above, so the specific features in the one or more embodiments of the image iterative decomposition apparatus provided below may be understood with reference to the features of the image iterative decomposition method above and will not be repeated here.

In an embodiment, as shown in FIG. 15, an image iterative decomposition apparatus is provided, including a noise model module 1401, a priori image module 1402, and a material density module 1403.

The noise model module 1401 is configured to determine a noise model based on scanned images of an object to be examined at different scan energies. The noise model represents noise distribution information of each scanned image.

The priori image module 1402 is configured to determine a priori material density image based on reference images at different scan energies.

The material density module 1403 is configured to construct an iterative decomposition function based on the scanned images, the noise model, and the prior material density image, and obtain a target material density image by solving the iterative decomposition function. The iterative decomposition function is configured to perform noise reduction and material decomposition on the scanned images, and the noise model is configured to balance a degree of noise reduction of each pixel in each scanned image.

In an embodiment, the noise model module 1401 includes:
a distribution submodule configured to for each scanned image at each scan energy, obtain a noise distribution image of each scanned image, the noise distribution image representing a noise level of each pixel in each scanned image; and
a model submodule configured to determine the noise model based on the noise distribution image of each scanned image.

In an embodiment, the priori image module 1402 includes:
an attenuation submodule configured to determine a reference linear attenuation coefficient image and a reference mass attenuation coefficient image of a material based on the reference images at different scan energies; and
an image submodule configured to determine the priori material density image based on the reference linear attenuation coefficient image and the reference mass attenuation coefficient image of the material.

In an embodiment, the material includes at least two components, the at least two components include a first component and a second component. The image submodule is configured to determine a priori material density image of the first component based on the reference linear attenuation coefficient image and a reference mass attenuation coefficient image of the first component; and determine a priori material density image of the second component based on the reference linear attenuation coefficient image, the reference mass attenuation coefficient image of the first component, a reference mass attenuation coefficient image of the second component, and a density of the first component.

In an embodiment, the material includes at least two of water, iodine, calcium or uric acid.

In an embodiment, the first component is water and the second component is iodine, and the image submodule includes:
a water density unit configured to determine a priori material density image of water based on the reference linear attenuation coefficient image and a reference mass attenuation coefficient image of water; and
an iodine density unit configured to determine a priori material density image of iodine based on the reference linear attenuation coefficient image, the reference mass attenuation coefficient image of water, a reference mass attenuation coefficient image of iodine, and a density of water.

In an embodiment, the water density unit includes:
a first ratio subunit configured to obtain a water coefficient ratio of a reference linear attenuation coefficient of each pixel to a reference mass attenuation coefficient of water based on the reference linear attenuation coefficient image and the reference mass attenuation coefficient image of water;
a restoration processing subunit configured to compare the water coefficient ratio of each pixel with a preset threshold, set the water coefficient ratio that is greater than the preset threshold to be equal to the preset threshold, and perform noise restoration on the water coefficient ratio greater than the preset threshold; and
a first density subunit configured to obtain the prior material density image of water based on the water coefficient ratio that is less than or equal to the preset threshold and the water coefficient ratio obtained after noise restoration.

In an embodiment, the iodine density unit includes:
a material contribution subunit configured to determine a part of an attenuation coefficient in an attenuation coefficient image contributed by iodine based on the reference linear attenuation coefficient image, the reference mass attenuation coefficient image of water, and the density of water;
a second ratio subunit configured to obtain an iodine coefficient ratio of a linear attenuation coefficient of each pixel to a reference mass attenuation coefficient of iodine based on the attenuation coefficient image of iodine and the reference mass attenuation coefficient image of iodine; and
a second density subunit configured to obtain the priori material density image of iodine based on the iodine coefficient ratio of each pixel.

In an embodiment, the second ratio subunit is further configured to perform sign processing on the iodine coefficient ratio of each pixel to obtain an iodine coefficient ratio of each pixel after sign processing; and obtain the priori material density image of iodine based on the iodine coefficient ratio of each pixel after sign processing.

In an embodiment, the material density module 1403 includes:
an iterative update submodule configured to input the scanned images, the noise model, the prior material density image and an initial material density image into the iterative decomposition function for iterative updating until an iteration stop condition is met to obtain the target material density image, the iterative decomposition function including a fidelity term and a regularization term, the fidelity term representing a difference between a linear attenuation coefficient image corresponding to the material density image and a linear attenuation coefficient image of the scanned image, and the regularization term being configured to correct an intermediate material density image output by the fidelity term.

In an embodiment, the regularization term includes a first regularization term for smoothing and denoising the material density image, and a second regularization term for representing a difference between the material density image and the priori material density image.

In an embodiment, a computer device is provided, including a memory and a processor. The memory stores a computer program, and the processor, when executing the computer program, implements steps of any image iterative decomposition method described above.

In an embodiment, a non-transitory computer-readable storage medium is provided, having a computer program stored therein. When the computer program is executed by a processor, steps of any image iterative decomposition method described above are implemented.

In an embodiment, a computer program product is provided, including a computer program. When the computer program is executed by a processor, steps of any image iterative decomposition method described above are implemented.

A person of ordinary skill in the art may understand that implementation of all or part of the processes in the methods of the above embodiments may be completed by instructing the relevant hardware through a computer program. The computer program may be stored in a non-transitory computer-readable storage medium. When the computer program is executed, it may include the processes of the respective methods according to the foregoing embodiments. Any reference to memory, database or other medium used of the embodiments provided in the present disclosure may include at least one of a non-transitory or a transitory memory. The non-transitory memory may include a read-only memory (ROM), a magnetic tape, a floppy disk, a flash memory, an optical memory, a high-density embedded non-transitory memory, a resistive random-access memory (ReRAM), a magneto resistive random-access memory (MRAM), a ferroelectric random-access memory (FRAM), a phase change memory (PCM), or a graphene memory, etc. The transitory memory may include a random-access memory (RAM) or an external cache memory, etc. As an illustration rather than a limitation, the random-access memory may be in various forms, such as a static random-access memory (SRAM) or a dynamic random-access memory (DRAM), etc. The databases involved in the embodiments provided by the present disclosure may include at least one of a relational database and a non-relational database. The non-relational database may include, but is not limited to, a blockchain-based distributed database, etc. The processor involved in the embodiments provided by the present disclosure may be, but is not limited to, a general purpose processor, a central processor, a graphics processor, a digital signal processor, a programmable logic device, a data processing logic device based on quantum computation, and the like.

The technical features in the above embodiments may be combined arbitrarily. For concise description, not all possible combinations of the technical features in the above embodiments are described. However, provided that they do not conflict with each other, all combinations of the technical features are to be considered to be within the scope of protection of the present disclosure.

The above-mentioned embodiments only describe several implementations of the present disclosure, and their description is specific and detailed, but should not be understood as a limitation on the protection scope of the present disclosure. It should be noted that, for a person of ordinary skill in the art, various variations and improvements can be further made without departing from the conception of the present disclosure, and these all fall within the protection scope of the present disclosure. Therefore, the protection scope of the present disclosure should be subject to the appended claims.

What is claimed is:

1. An image iterative decomposition method, comprising:
determining a noise model based on scanned images of an object to be examined at different scan energies, the noise model representing noise distribution information of each scanned image;
constructing an iterative decomposition function based on the scanned images and the noise model, the iterative decomposition function being configured to perform noise reduction and material decomposition on the scanned images; and
obtaining a target material density image by solving the iterative decomposition function.

2. The image iterative decomposition method of claim 1, wherein determining the noise model based on the scanned images of the object to be examined at different scan energies comprises:
for each scanned image at each scan energy, obtaining a noise distribution image of each scanned image, the noise distribution image representing a noise level of each pixel in each scanned image; and
determining the noise model based on the noise distribution image of each scanned image.

3. The image iterative decomposition method of claim 1, wherein after determining the noise model based on the scanned images of the object to be examined at different scan energies, the method further comprises:
determining a priori material density image based on reference images at different scan energies;
wherein constructing the iterative decomposition function based on the scanned images and the noise model comprises:
determining the iterative decomposition function based on the scanned images, the noise model, and the priori material density image.

4. The image iterative decomposition method of claim 3, wherein determining the prior material density image based on the reference images at different scan energies comprises:
determining a reference linear attenuation coefficient image and a reference mass attenuation coefficient image of a material based on the reference images at different scan energies; and
determining the priori material density image based on the reference linear attenuation coefficient image and the reference mass attenuation coefficient image of the material.

5. The image iterative decomposition method of claim 4, wherein the material comprises at least two components, the at least two components comprise a first component and a second component, and determining the priori material density image based on the reference linear attenuation coefficient image and the reference mass attenuation coefficient image of the material comprises:
determining a priori material density image of the first component based on the reference linear attenuation coefficient image and a reference mass attenuation coefficient image of the first component; and
determining a priori material density image of the second component based on the reference linear attenuation coefficient image, the reference mass attenuation coefficient image of the first component, a reference mass attenuation coefficient image of the second component, and a density of the first component.

6. The image iterative decomposition method of claim 5, wherein the material comprises at least two of water, iodine, calcium or uric acid.

7. The image iterative decomposition method of claim 5, wherein the first component is water and the second component is iodine, and determining the prior material density image based on the reference linear attenuation coefficient image and the reference mass attenuation coefficient image of the material comprises:
determining a priori material density image of water based on the reference linear attenuation coefficient image and a reference mass attenuation coefficient image of water; and
determining a priori material density image of iodine based on the reference linear attenuation coefficient image, the reference mass attenuation coefficient image of water, a reference mass attenuation coefficient image of iodine, and a density of water.

8. The image iterative decomposition method of claim 7, wherein determining the prior material density image of water based on the reference linear attenuation coefficient image and the reference mass attenuation coefficient image of water comprises:
obtaining a water coefficient ratio of a reference linear attenuation coefficient of each pixel to a reference mass attenuation coefficient of water based on the reference linear attenuation coefficient image and the reference mass attenuation coefficient image of water;
comparing the water coefficient ratio of each pixel with a preset threshold, setting the water coefficient ratio that is greater than the preset threshold to be equal to the preset threshold, and performing noise restoration on the water coefficient ratio greater than the preset threshold; and
obtaining the prior material density image of water based on the water coefficient ratio that is less than or equal to the preset threshold and the water coefficient ratio obtained after noise restoration.

9. The image iterative decomposition method of claim 7, wherein determining the priori material density image of iodine based on the reference linear attenuation coefficient image, the reference mass attenuation coefficient image of water, the reference mass attenuation coefficient image of iodine, and the density of water comprises:
determining a part of an attenuation coefficient in an attenuation coefficient image contributed by iodine based on the reference linear attenuation coefficient image, the reference mass attenuation coefficient image of water, and the density of water;
obtaining an iodine coefficient ratio of a linear attenuation coefficient of each pixel to a reference mass attenuation coefficient of iodine based on the attenuation coefficient image of iodine and the reference mass attenuation coefficient image of iodine; and
obtaining the priori material density image of iodine based on the iodine coefficient ratio of each pixel.

10. The image iterative decomposition method of claim 9, wherein obtaining the prior material density image of iodine based on the iodine coefficient ratio of each pixel comprises:
performing sign processing on the iodine coefficient ratio of each pixel to obtain an iodine coefficient ratio of each pixel after sign processing; and
obtaining the priori material density image of iodine based on the iodine coefficient ratio of each pixel after sign processing.

11. The image iterative decomposition method of claim 1, wherein obtaining the target material density image by solving the iterative decomposition function comprises:
inputting an initial material density image into the iterative decomposition function for iterative updating until an iteration stop condition is met to obtain the target material density image, the iterative decomposition function comprising a fidelity term and a regularization term, the fidelity term representing a difference between a linear attenuation coefficient image corresponding to the material density image and a linear attenuation coefficient image of the scanned image, and the regularization term being configured to correct an intermediate material density image output by the fidelity term.

12. The image iterative decomposition method of claim 11, wherein the regularization term comprises a first regularization term for smoothing and denoising the material density image, and a second regularization term for representing a difference between the material density image and the priori material density image.

13. An image iterative decomposition method, comprising:
obtaining scanned images of an object to be examined at different scan energies;
determining a priori material density image based on linear attenuation coefficient images at different scan energies;
constructing an iterative decomposition function based on the scanned images and the prior material density image, the iterative decomposition function being configured to perform noise reduction and material decomposition on the scanned images; and
obtaining a target material density image by solving the iterative decomposition function.

14. The image iterative decomposition method of claim 13, wherein after obtaining the scanned images of the object to be examined at different scan energies, the method further comprises:
determining a noise model based on the scanned images of the object to be examined at different scan energies, the noise model representing noise distribution information of each scanned image;
wherein constructing the iterative decomposition function based on the scanned images and the prior material density image comprises:
determining the iterative decomposition function based on the scanned images, the noise model, and the prior material density image.

15. The image iterative decomposition method of claim 14, wherein determining the noise model based on the scanned images of the object to be examined at different scan energies comprises:
for each scanned image at each scan energy, obtaining a noise distribution image of each scanned image, the noise distribution image representing a noise level of each pixel in each scanned image; and
determining the noise model based on the noise distribution image of each scanned image.

16. A computer device comprising a memory and a processor, the memory storing a computer program, wherein the computer program, when executed by the processor, causes the processor to perform:
determining a noise model based on scanned images of an object to be examined at different scan energies, the noise model representing noise distribution information of each scanned image;
constructing an iterative decomposition function based on the scanned images and the noise model, the iterative decomposition function being configured to perform noise reduction and material decomposition on the scanned images; and
obtaining a target material density image by solving the iterative decomposition function.

17. The computer device of claim 16, wherein determining the noise model based on the scanned images of the object to be examined at different scan energies comprises:
for each scanned image at each scan energy, obtaining a noise distribution image of each scanned image, the noise distribution image representing a noise level of each pixel in each scanned image; and
determining the noise model based on the noise distribution image of each scanned image.

18. The computer device of claim 16, wherein the computer program, when executed by the processor, further causes the processor to perform:
determining a priori material density image based on reference images at different scan energies;
wherein constructing the iterative decomposition function based on the scanned images and the noise model comprises:
determining the iterative decomposition function based on the scanned images, the noise model, and the priori material density image.

19. The computer device of claim 18, wherein determining the prior material density image based on the reference images at different scan energies comprises:
determining a reference linear attenuation coefficient image and a reference mass attenuation coefficient image of a material based on the reference images at different scan energies; and
determining the priori material density image based on the reference linear attenuation coefficient image and the reference mass attenuation coefficient image of the material.

20. The computer device of claim 19, wherein the material comprises at least two components, the at least two components comprise a first component and a second component, and determining the priori material density image based on the reference linear attenuation coefficient image and the reference mass attenuation coefficient image of the material comprises:
determining a priori material density image of the first component based on the reference linear attenuation coefficient image and a reference mass attenuation coefficient image of the first component; and
determining a priori material density image of the second component based on the reference linear attenuation coefficient image, the reference mass attenuation coefficient image of the first component, a reference mass attenuation coefficient image of the second component, and a density of the first component.
